(19) United States
(12) Patent Application Publication
(10) Pub. No.: US 2021/0358231 A1
(43) Pub. Date: Nov. 18, 2021

(54) VEHICLE MONITORING DEVICE, VEHICLE MONITORING METHOD, AND RECORDING MEDIUM

(71) Applicant: HONDA MOTOR CO., LTD., Tokyo (JP)

(72) Inventor: Shuichi Kazuno, Wako-shi (JP)

(21) Appl. No.: 17/316,751

(22) Filed: May 11, 2021

(30) Foreign Application Priority Data
May 15, 2020 (JP) 2020-085996

(51) Int. Cl. G07C 5/00; G07C 5/08; B60L 58/12

(52) U.S. Cl. CPC G07C 5/008; B60K 6/28; B60L 58/12; G07C 5/0808

(57) ABSTRACT

A vehicle monitoring device includes a communication part that communicates with one or more vehicles, an acquisition part configured to acquire identification information of the vehicle and starting information of a driving source of the vehicle from the vehicle using the communication part, and a processing part configured to extract a specified vehicle, a driving source of which is not started for a predetermined period or more, on the basis of the starting information and to perform a process corresponding to the specified vehicle.

### CROSS-REFERENCE TO RELATED APPLICATION

Priority is claimed on Japanese Patent Application No. 2020-085996, filed May 15, 2020, the content of which is incorporated herein by reference.

### BACKGROUND OF THE INVENTION

### Field of the Invention

The present invention relates to a vehicle monitoring device, a vehicle monitoring method, and a recording medium.

### Description of Related Art

In recent years, in the fields of smart cities and car sharing, a system for increasing a working rate of vehicles and effectively utilizing the vehicles by allowing a plurality of users to use one vehicle is known (for example, Japanese Unexamined Patent Application, First Publication No. 2002-245585, Japanese Unexamined Patent Application, First Publication No. 2007-112324, Japanese Unexamined Patent Application, First Publication No. 2010-181986).

### SUMMARY OF THE INVENTION

However, vehicles may not be used for a long time in a district or a time zone in which user's needs are low, and effective ways of utilizing such vehicles have not been sufficiently examined.

An aspect of the present invention is directed to providing a vehicle monitoring device, a vehicle monitoring method, and a recording medium that are capable of effectively utilizing vehicles that are not used.

A vehicle monitoring device according to the present invention employs the following configurations.

(1) A vehicle monitoring device according to an aspect of the present invention includes a communication part that communicates with one or more vehicles; an acquisition part configured to acquire identification information of the vehicle and starting information of a driving source of the vehicle from the vehicle using the communication part; and a processing part configured to extract a specified vehicle, a driving source of which is not started for a predetermined period or more, on the basis of the starting information and to perform a process corresponding to the specified vehicle.

(2) In the aspect of the above-mentioned (1), the acquisition part may further acquire position information of the vehicle, and the processing part may generate information in which positions of the specified vehicles are mapped on the basis of the position information.

(3) In the aspect of the above-mentioned (1) or (2), the driving source of the vehicle may include a secondary battery, the acquisition part may further acquire charge/discharge information of the secondary battery, and the processing part may perform degradation diagnosis of the secondary battery of the vehicle on the basis of a period in which the driving source of the vehicle is not started and the charge/discharge information.

(4) In the aspect of the above-mentioned (3), among a plurality of vehicles that acquired the charge/discharge information, the processing part may perform the degradation diagnosis of the specified vehicle with a second standard, the second standard being different from a first standard which is used when degradation diagnosis of a non-specified vehicle that is not the specified vehicle is performed, and the second standard with accuracy higher than that of the first standard.

(5) In the aspect of the above-mentioned (3) or (4), the acquisition part may further acquire position information of the vehicle, and the processing part may generate information in which the position of the specified vehicle is mapped and in which displays the degradation diagnosis result in association with the position of the specified vehicle on a map.

(6) In the aspect of any one of the above-mentioned (3) to (5), the processing part may derive a supply power when used as a power feeding device in a specified situation on the basis of the degradation diagnosis result.

(7) In the aspect of any one of the above-mentioned (1) to (6), the communication part may communicate with a terminal device of a manager who manages the specified vehicle, and transmits a notification that recommends power feeding from the specified vehicle to an external power supply device with respect to the terminal device of the manager.

(8) In the aspect of the above-mentioned (1) to (7), in a case there are a plurality of first specified vehicles, the first specified vehicle being a vehicle managed by a first manager and a vehicle being extracted as the specified vehicle, the acquisition part may further acquire position information of the first specified vehicles, and the processing part may generate information in which positions of the first specified vehicles are mapped on the basis of the position information of the first specified vehicles.

(9) A vehicle monitoring method according to an aspect of the present invention is performed by a computer, the method including communicating with one or more vehicles; acquiring identification information of the vehicle and starting information of a driving source of the vehicle from the vehicle; extracting a specified vehicle, a driving source of which is not started for a predetermined period or more, on the basis of the starting information; and performing a process corresponding to the specified vehicle.

(10) A program according to an aspect of the present invention is stored in a computer-readable recording medium to cause a computer to communicate with one or more vehicles; acquire identification information of the vehicle and starting information of a driving source of the vehicle from the vehicle; extract a specified vehicle, a driving source of which is not started for a predetermined period or more, on the basis of the starting information; and perform a process corresponding to the specified vehicle.

According to the aspect of the above-mentioned (1) to (10), it is possible to effectively use vehicles that are not in use.

### BRIEF DESCRIPTION OF THE DRAWINGS

FIG. 1 is a view showing an example of a vehicle monitoring system including a vehicle monitoring device according to the present invention.

FIG. 2 is a view showing an example of a configuration of a vehicle.

FIG. 3 is a view showing an example of a configuration of a vehicle monitoring server device.

FIG. 4 is a view showing an example of contents of a situation information table.

FIG. 5 is a view showing an example of contents of a continuous IG OFF time table.

FIG. 6 is a view showing an example of a specified vehicle map.

FIG. 7 is a view showing an example of contents of a charge/discharge information table.

FIG. 8 is a view showing an example of a battery degradation diagnosis space according to an embodiment.

FIG. 9 is a view showing an example of contents of a degradation diagnosis result table according to the embodiment.

FIG. 10 is a flowchart showing an example of a flow of processing of extraction of a specified vehicle and generation of a map by a vehicle monitoring server device.

FIG. 11 is a flowchart showing an example of a flow of processing of recommending degradation diagnosis of a battery and utilization of a vehicle by the vehicle monitoring server device.

FIG. 12 is a flowchart showing an example of a flow of processing of extraction of a power feeding vehicle and guarantee of electric power upon emergency by the vehicle monitoring server device.

FIG. 13 is a flowchart showing an example of a flow of processing of power feeding upon emergency by the vehicle monitoring server device.

### DETAILED DESCRIPTION OF THE INVENTION

### First Embodiment

Hereinafter, an embodiment of a vehicle monitoring device, a vehicle monitoring method, and a program of the present invention will be described with reference to the accompanying drawings.

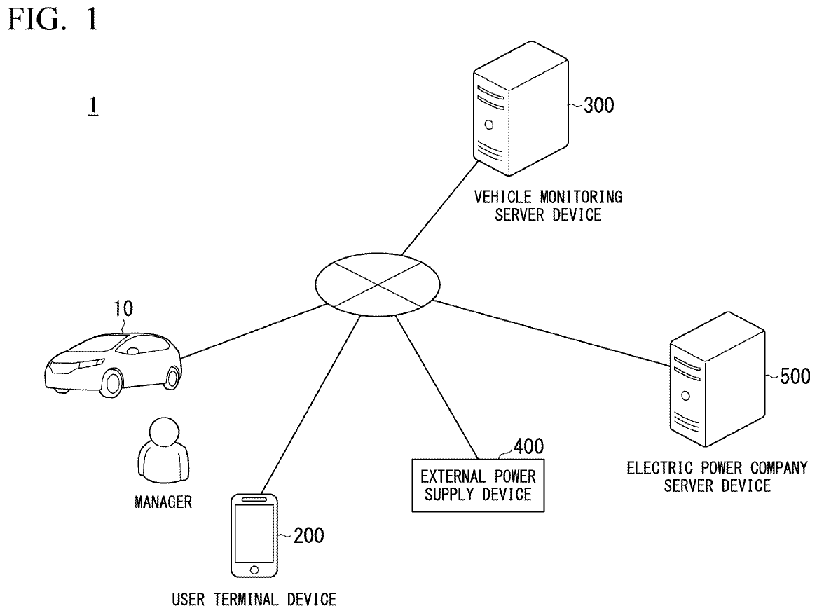

FIG. 1 is a view showing an example of a vehicle monitoring system 1 including a vehicle monitoring device according to the present invention. For example, the vehicle monitoring system 1 may be applied to a V2X (Vehicle to X) system. The V2X system is a general name of V2L (Vehicle to Load), V2H (Vehicle to Home), V2G (Vehicle to Grid), V2V (Vehicle to Vehicle), and the like. Hereinafter, an example in which a system to which the vehicle monitoring system 1 is applied is the V2G system, which is a system configured to perform interchanging of electric power between an electric power system including a commercial power network and an in-vehicle battery, will be described. The interchanging of the electric power includes both of power feeding from the electric power system to the in-vehicle battery and power feeding from the in-vehicle battery to the electric power system. In the V2X system, the in-vehicle battery of the vehicle is used as an electric power storage facility, and bidirectional exchange of electric power is performed between the vehicle participating the V2G system and the electric power system.

As shown in FIG. 1, the vehicle monitoring system 1 includes, for example, one or more vehicles 10, a user terminal device 200, a vehicle monitoring server device 300, one or more external power supply devices 400, and an electric power company server device 500. Further, the vehicle monitoring server device 300 is an example of the vehicle monitoring device according to the present invention. The one or more vehicles 10, the user terminal device 200, the vehicle monitoring server device 300, the one or more external power supply devices 400, and the electric power company server device 500 are connected via a network NW. Further, the network NW includes, for example, the Internet, a wide area network (WAN), a local area network (LAN), a provider device, a radio base station, and the like.

The vehicle 10 is, for example, an electric car on which a secondary battery is mounted, or an electric car provided with an exchangeable secondary battery. The vehicle 10 is, for example, a battery electric vehicle (BEV: electric car) traveling by a motor (electric motor) driven by electric power supplied from a traveling battery (a secondary battery). The vehicle 10 may be a four-wheeled vehicle, a three-wheeled vehicle, a saddle riding vehicle, a power-assisted bicycle, a cultivator, a management machine, a walking assisting device, a kickboard, or the like, on which a secondary battery is mounted or exchangeable.

The user terminal device 200 is a communication terminal owned by a manager of the vehicle 10, for example, a smartphone, a tablet terminal, a personal computer, or the like. The manager of the vehicle 10 includes an owner of the vehicle 10 that is a private vehicle, staff of a management company of the vehicle 10 used as a shared car, or the like.

The vehicle monitoring server device 300 monitors, for example, a usage situation or the like of the vehicle 10 on the basis of information or the like received from the vehicle 10.

The external power supply device 400 is installed in, for example, a user's home of the vehicle 10, a charging spot of the VtoX, a power supply spot of the VtoX, or the like. For example, the external power supply device 400 is electrically connected to the vehicle 10 via a cable, and exchanges electric power with the vehicle 10. In addition, the external power supply device 400 is connected to the electric power company server device 500 via the network NW. The external power supply device 400 is connected to the electric power system including a commercial power network.

The electric power company server device 500 is a server device used by an electric power company. The electric power company server device 500 is connected to the vehicle monitoring server device 300 and the external power supply device 400 via the network NW. The electric power company server device 500 controls the external power supply device 400 to perform supply of electric power from the vehicle 10 to the external power supply device 400 or controls the external power supply device 400 to perform supply of electric power from the external power supply device 400 to the vehicle 10 when the vehicle 10 and the external power supply device 400 are connected. As a result, for example, the electric power company server device 500 controls to perform exchange of electric power between the electric power system including the commercial power network and the vehicle 10.

Further, the electric power company server device 500 is an example of a server device used by a wide area surveillant. The wide area surveillant is not limited to the electric power company, and may include, for example, those who provide some service to a manager of the vehicle 10, those who manage the external power supply device 400, or the like.

### [Configuration of Vehicle 10]

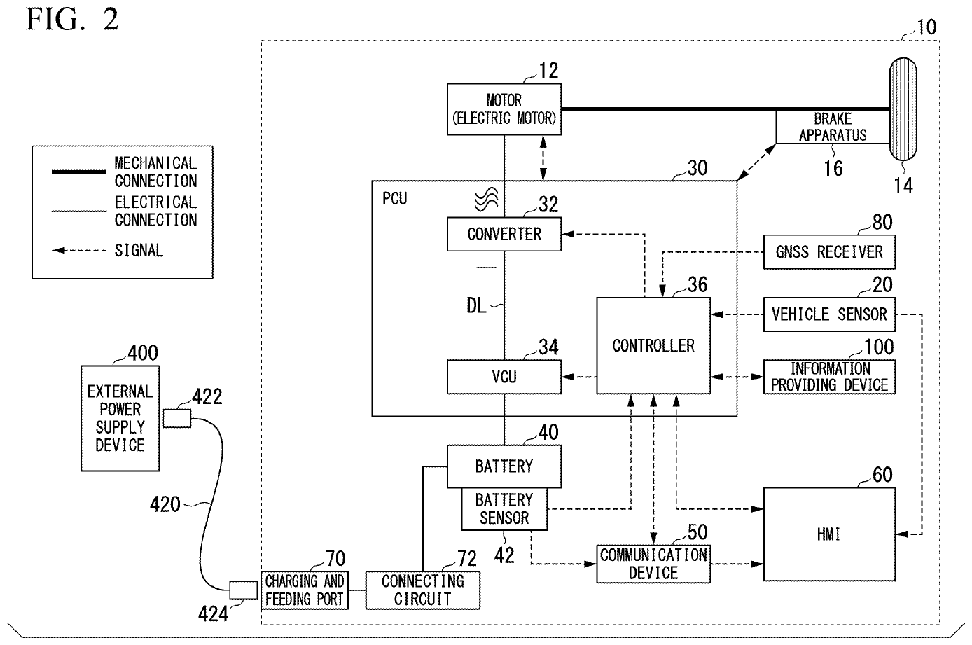

FIG. 2 is a view showing an example of a configuration of the vehicle 10.

As shown in FIG. 2, the vehicle 10 includes, for example, a motor 12, a driving wheel 14, a brake apparatus 16, a vehicle sensor 20, a power control unit (PCU) 30, a battery 40, a battery sensor 42 such as a voltage sensor, a current sensor, a temperature sensor, or the like, a communication device 50, a human machine interface (HMI) 60 including a display device, a charging and feeding port 70, a connecting circuit 72, a GNSS receiver 80, and an information providing device 100.

The motor 12 is, for example, a three-phase alternating current motor. A rotator (a rotor) of the motor 12 is connected to the driving wheel 14. The motor 12 is driven by electric power supplied from a power storage part (not shown) included in the battery 40, and transmits rotational power to the driving wheel 14. In addition, the motor 12 generates power using kinetic energy of the vehicle 10 upon deceleration of the vehicle 10.

The brake apparatus 16 includes, for example, a brake caliper, a cylinder configured to transmit a hydraulic pressure to the brake caliper, and an electric motor configured to generate a hydraulic pressure in the cylinder. The brake apparatus 16 may include a mechanism configured to transmit the hydraulic pressure generated by an operation performed by a user (driver) of the vehicle 10 on a brake pedal (not shown) to the cylinder via the master cylinder as a back-up. Further, the brake apparatus 16 is not limited to the above-mentioned configuration and may be an electronically controlled hydraulic brake apparatus configured to transmit a hydraulic pressure of a master cylinder to a cylinder.

The vehicle sensor 20 includes, for example, an accelerator position sensor, a vehicle speed sensor, and a brake depression sensor. The accelerator position sensor is attached to an accelerator pedal, detects a depression amount of the accelerator pedal from the driver, and outputs the detected depression amount to a controller 36 included in the PCU 30 as an accelerator position. The vehicle speed sensor includes, for example, a wheel speed sensor and a speed calculator attached to each wheel of the vehicle 10, derives a speed of the vehicle 10 (a vehicle speed) by integrating wheel speeds detected by the wheel speed sensors, and outputs the derived speed to the controller 36 and the HMI 60. The brake depression sensor is attached to the brake pedal, detects a depression amount of the brake pedal from the driver, and outputs the detected depression amount to the controller 36 as a brake depression amount.

The PCU 30 includes, for example, a converter 32, a voltage control unit (VCU) 34, and the controller 36. Note that the combined configuration of these components as the PCU 30 shown in FIG. 2 is one example, and these components in the vehicle 10 may be arranged in a distributed manner.

The converter 32 is, for example, an AC-DC converter. A DC-side terminal of the converter 32 is connected to a direct current link DL. The battery 40 is connected to the direct current link DL via the VCU 34. The converter 32 converts an alternating current generated by the motor 12 into a direct current and outputs the converted direct current to the direct current link DL.

The VCU 34 is, for example, a DC-DC converter. The VCU 34 boosts the electric power supplied from the battery 40 and outputs the boosted electric power to the direct current link DL.

The controller 36 includes, for example, a motor controller, a brake controller, a battery/VCU controller, and an electric power supply controller. The motor controller, the brake controller, the battery/VCU controller, and the electric power supply controller may be replaced with separate control devices, for example, control devices such as a motor electronic control unit (ECU), a brake ECU, a battery ECU, and an electric power supply control ECU.

In addition, the controller 36, or the motor controller, the brake controller, the battery/VCU controller and the electric power supply controller included in the controller 36 are realized by executing a program (software) using a hardware processor such as a central processing unit (CPU) or the like. In addition, some or all of these components may be realized by hardware (a circuit part; including circuitry) such as large scale integration (LSI), an application specific integrated circuit (ASIC), a field-programmable gate array (FPGA), a graphics processing unit (GPU), or the like, or may be realized by software and hardware in cooperation. In addition, some of all functions of these components may be realized by a dedicated LSI. The program may be stored in a storage device (a storage device including a non-transient recording medium) such as a hard disk drive (HDD), a flash memory, or the like included in the vehicle 10 in advance, or stored in a detachable recording medium (a non-transient recording medium) such as a DVD, a CD-ROM, or the like, and installed in an HDD or a flash memory included in the vehicle 10 by mounting a recording medium in a drive device included in the vehicle 10.

A motor controller of the controller 36 controls driving of the motor 12 on the basis of the output from the accelerator position sensor included in the vehicle sensor 20. The brake controller of the controller 36 controls the brake apparatus 16 on the basis of the output from the brake depression sensor included in the vehicle sensor 20. The battery/VCU controller of the controller 36 calculates, for example, a state of charge (SOC; hereinafter, also referred to as “a battery charging rate”) of the battery 40 on the basis of the output from the battery sensor 42 connected to the battery 40, and outputs the SOC to the VCU 34, the HMI 60, and the information providing device 100. The derived SOC is an example of a residual energy quantity of the battery 40. The controller 36 may output information of a vehicle speed output by the vehicle sensor 20 to the HMI 60. The VCU 34 increases a voltage of the direct current link DL according to an instruction from the battery/VCU controller.

The electric power supply controller of the controller 36 controls the electric power stored in the battery 40, for example, when electric power is supplied to the external power supply device 400 connected to the vehicle 10.

The battery 40 is a secondary battery capable of repeating charge and discharge, for example, a lithium ion battery or the like. As the secondary battery that constitutes the battery 40, for example, in addition to a lead storage battery, a nickel hydrogen battery, a sodium ion battery, or the like, a capacitor such as an electric double layer capacitor or the like, or a compound battery in which a secondary battery and a capacitor are combined can also be considered. Further, in the present invention, the configuration of the secondary battery in the battery 40 is not particularly defined. In addition, the battery 40 may be detachably attached to the vehicle 10, for example, it may be a battery pack such as a cassette type or the like. The battery 40 accumulates electric power introduced from the external power supply device 400 of the vehicle 10, and performs discharge for traveling of the vehicle 10.

The battery sensor 42 includes, for example, a current sensor, a voltage sensor, a temperature sensor, and the like. The battery sensor 42 detects, for example, a current value, a voltage value, a temperature, and the like upon charge/discharge of the battery 40. The battery sensor 42 outputs the detected current value, voltage value, temperature, or the like to the information providing device 100 or the controller 36.

The communication device 50 includes a wireless module configured to connect a cellular network or a Wi-Fi network. The communication device 50 may include a wireless module to use Bluetooth (registered trademark) or the like. The communication device 50 transmits various pieces of information related to the vehicle 10 to the vehicle monitoring server device 300 via, for example, a network NW through communication in the wireless module. There is no limitation thereto, and the vehicle 10 may communicate with the external power supply device 400 via a signal cable included in a charging and feeding cable 420 (for example, serial communication), which will be described below, without using the communication device 50, and may be connected to the network NW using a communication function of causing the external power supply device 400 to communicate with the network NW.

The HMI 60 presents various pieces of information to the user of the vehicle 10 such as a driver or the like, and receives input operations from the user. The HMI 60 is a so-called touch panel, which is a combination of a display device such as a liquid crystal display (LCD) or the like and an input device that detects an input operation. The HMI 60 may include various types of display parts other than the display device, a speaker, a buzzer, a switch other than the input device, a key, or the like. The HMI 60 may share the display device or the input device with a display device or an input device such as an in-vehicle navigation device or the like.

The charging and feeding port 70 is a mechanism configured to charge the battery 40 or supply power from the battery 40. The charging and feeding port 70 is provided toward the outside of the vehicle body of the vehicle 10. The charging and feeding port 70 is connected to the external power supply device 400 via the charging and feeding cable 420. The charging and feeding cable 420 includes a first plug 422 and a second plug 424. The first plug 422 is connected to the external power supply device 400, and the second plug 424 is connected to the charging and feeding port 70. When the battery 40 is charged, electricity supplied from the external power supply device 400 is input to the charging and feeding port 70 via the charging and feeding cable 420. When power is supplied from the battery 40, electricity output from the charging and feeding port 70 via the charging and feeding cable 420 is supplied to the external power supply device 400.

In addition, the charging and feeding cable 420 includes a signal cable attached to the electric power cable. The signal cable mediates communication between the vehicle 10 and the external power supply device 400. Accordingly, an electric power connector configured to connect the electric power cable and a signal connector configured to connect the signal cable are provided on the first plug 422 and the second plug 424.

The connecting circuit 72 is provided between the charging and feeding port 70 and the battery 40. The connecting circuit 72 transmits the current introduced from the external power supply device 400 via the charging and feeding port 70, for example, a direct current, as a current to be supplied to the battery 40. The connecting circuit 72 outputs, for example, the direct current to the battery 40, and accumulates (charges) the electric power in the battery 40 (the secondary battery).

The GNSS receiver 80 measures a position of the vehicle 10 on the basis of radio waves coming from a GNSS satellite (for example, a GPS satellite). The GNSS receiver 80 outputs the positioning result to the information providing device 100.

The information providing device 100 transmits various pieces of information to the vehicle monitoring server device 300 via the network NW using the communication device 50. The information providing device 100 may transmit various pieces of information periodically, and may transmit the information at the timing required by the vehicle monitoring server device 300.

For example, the information providing device 100 generates vehicle situation information indicating a situation of the vehicle 10, and transmits the generated vehicle situation information to the vehicle monitoring server device 300. The vehicle situation information is information indicating how long the vehicle is stopped in a state in which ignition is OFF, information indicating a residual energy quantity of the battery 40, or the like, which will be described below in detail. In addition, the information providing device 100 may include the position information measured by the GNSS receiver 80 in the vehicle situation information as information indicating the current position of the vehicle 10.

In addition, the information providing device 100 generates charge/discharge information on the basis of the detection result by the battery sensor 42, and transmits the generated charge/discharge information to the vehicle monitoring server device 300. For example, the information providing device 100 generates physical quantity data indicating a physical quantity related to the state of the battery 40 on the basis of the detection result. The physical quantity includes, for example, a battery charging rate (SOC), an open circuit voltage (OCV) of the battery 40, an internal resistance of the battery 40, a capacity of the battery 40, and the like. These physical quantities are hereinafter referred to as battery parameters. The information providing device 100 generates charge/discharge information on the basis of the physical quantity data. Further, the charge/discharge information may include physical quantity time data indicating a temporal change of battery parameters, for example, data indicating a temporal change of the charging rate of the battery 40, or the like.

There is no limitation thereto, and the battery parameters may include SOC-OCV curve characteristics, an environment temperature of the battery 40, a capacity upon full charge, and the like, and the information providing device 100 may generate physical quantity data including the SOC-OCV curve characteristics, the environment temperature of the battery 40, the capacity upon full charge, and the like on the basis of the detection result by the battery sensor 42 and include the generated data in the charge/discharge information.

Further, the information providing device 100 may be included (built) in, for example, the PCU 30 or the controller 36.

### [Configuration of Vehicle Monitoring Server Device 300]

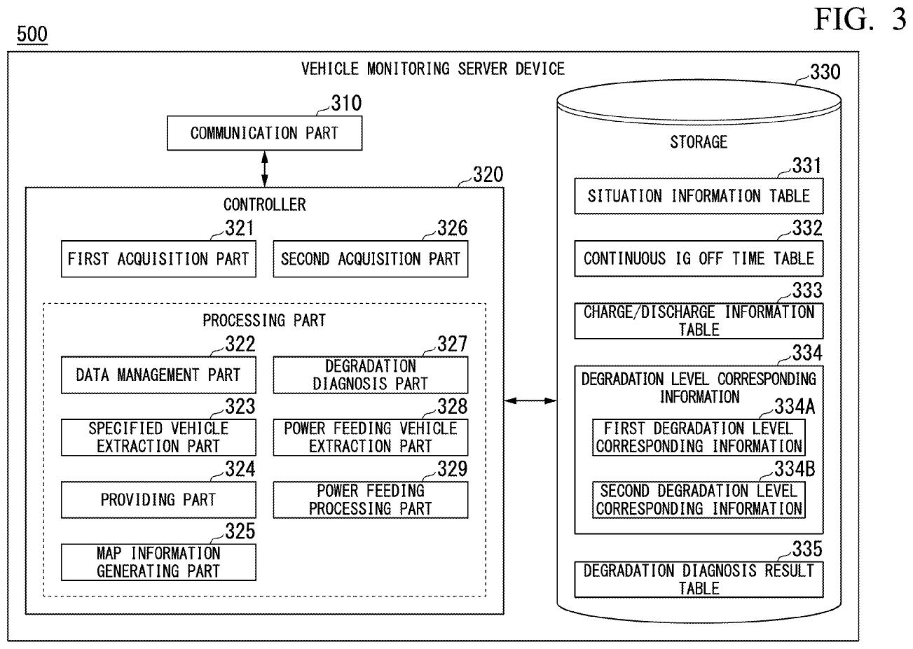

FIG. 3 is a view showing an example of a configuration of the vehicle monitoring server device 300. The vehicle monitoring server device 300 includes, for example, a communication part 310, a controller 320, and a storage 330. For example, a situation information table 331, a continuous IG OFF time table 332, a charge/discharge information table 333, degradation level correspondence information 334, and a degradation diagnosis result table 335 are stored in the storage 330. Contents of these tables will be described below in detail.

The communication part 310 includes a wireless module configured to connect a wireless communication network such as a cellular network or the like.

The controller 320 includes, for example, a first acquisition part 321, a data management part 322, a specified vehicle extraction part 323, a providing part 324, a map information generating part 325, a second acquisition part 326, a degradation diagnosis part 327, a power feeding vehicle extraction part 328, and a power feeding processing part 329. The first acquisition part 321, the data management part 322, the specified vehicle extraction part 323, the providing part 324, the map information generating part 325, the second acquisition part 326, the degradation diagnosis part 327, the power feeding vehicle extraction part 328, and the power feeding processing part 329 are realized by executing a program (software) using a hardware processor such as a CPU or the like. In addition, some or all of these components may be realized by hardware (a circuit part; including circuitry) such as an LSI, an ASIC, an FPGA, a GPU, or the like, or may be realized by software and hardware in cooperation. In addition, some or all functions of these components may be realized by a dedicated LSI. The program may be stored in a storage device (a storage device including a non-transient recording medium) such as an HDD, a flash memory, or the like included in the vehicle monitoring server device 300 in advance, may be stored in a detachable recording medium (a non-transient recording medium) such as a DVD, a CD-ROM, or the like, and installed in an HDD or a flash memory included in the vehicle monitoring server device 300 by mounting the recording medium in a drive device included in the vehicle monitoring server device 300.

For example, the first acquisition part 321 and the second acquisition part 326 are an example of an acquisition part configured to acquire information from the vehicle 10 using the communication part 310. The data management part 322, the specified vehicle extraction part 323, the providing part 324, the map information generating part 325, the second acquisition part 326, the degradation diagnosis part 327, the power feeding vehicle extraction part 328, and the power feeding processing part 329 are an example of a processing part configured to perform some processing on the vehicle on the basis of the acquired information.

### [With Respect to Specified Vehicle]

The first acquisition part 321 acquires various pieces of information from the vehicle 10 via the network NW using the communication part 310. For example, the first acquisition part 321 acquires vehicle situation information periodically from the vehicle 10. The first acquisition part 321 may acquire vehicle situation information by transmitting a notification that requires transmission of the vehicle situation information to the vehicle 10 periodically, or acquire vehicle situation information transmitted from the vehicle 10 side voluntarily at predetermined times or predetermined time intervals.

The vehicle situation information includes at least identification information (hereinafter referred to as a vehicle ID) uniquely allocated to each of the vehicles 10, and starting information indicating presence or absence of starting of the driving source of the vehicle 10. The driving source includes, for example, the motor 12 and the battery 40. The starting information is, for example, information indicating whether ignition is in an ON state or ignition is in an OFF state. Hereinafter, the starting information is referred to as the ignition information.

The vehicle situation information may further include information indicating the current position of the vehicle 10 (hereinafter referred to as vehicle position information), information indicating a date and time acquired by the vehicle situation information (hereinafter referred to as acquisition date and time information), and information indicating a residual energy quantity of the vehicle 10 (hereinafter, referred to as residual energy quantity information). The residual energy quantity is, for example, an SOC.

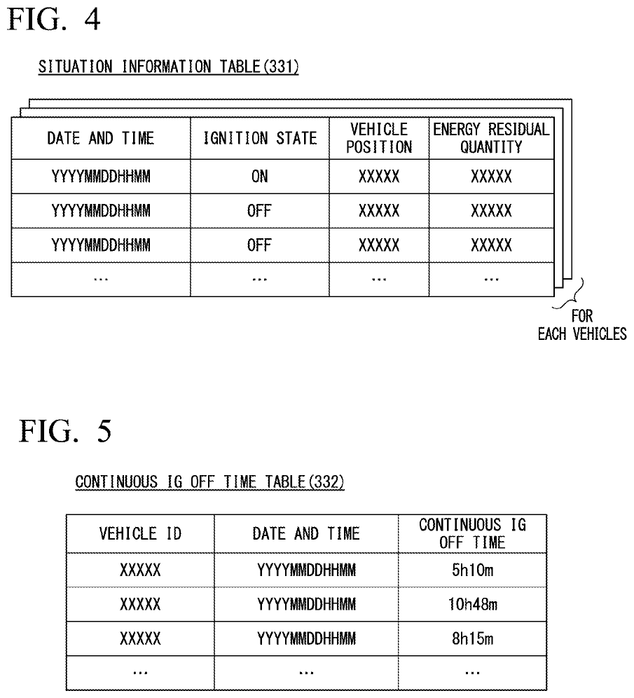

The data management part 322 stores the vehicle situation information acquired by the first acquisition part 321 as a part of the situation information table 331. FIG. 4 is a view showing an example of contents of the situation information table 331. The situation information table 331 is, for example, a table of information in which an ignition state, a vehicle position and a residual energy quantity are associated with the date and time, and is provided in each of the vehicles 10. In the situation information table 331, the date and time is acquisition date and time information, the ignition state is ignition information, the vehicle position is vehicle position information, and the residual energy quantity is residual energy quantity information.

The specified vehicle extraction part 323 refers to the storage 330, and extracts a vehicle in which a driving source is not started for a predetermined period or more (hereinafter referred to as a specified vehicle). For example, the specified vehicle extraction part 323 refers to the situation information table 331, and derives a length of a time from a date and time T1 when ignition of the situation information table 331 is changed from the ON state to the OFF state until a date and time T2 when the ignition is changed from the OFF state to the ON state (hereinafter referred to as a continuous IG OFF time). The specified vehicle extraction part 323 associates the derived continuous IG OFF time with the vehicle ID, and stores the derived continuous IG OFF time in the storage 330 as a part of the continuous IG OFF time table 332.

FIG. 5 is a view showing an example of contents of the continuous IG OFF time table 332. The continuous IG OFF time table 332 is, for example, information in which the date and time and the continuous IG OFF time are associated with the vehicle ID. The date and time may be a date and time when the continuous IG OFF time is derived, or may be the date and time T2 when the ignition is changed from the OFF state to the ON state. The specified vehicle extraction part 323 extracts the vehicle 10 in which the continuous IG OFF time is a threshold or more as the specified vehicle. For example, the threshold is a time length corresponding to several days.

The providing part 324 performs predetermined processing corresponding to the specified vehicle extracted by the specified vehicle extraction part 323. For example, when the specified vehicle is extracted by the specified vehicle extraction part 323, the providing part 324 transmits the predetermined information to the user terminal device 200 of the manager who manages the specified vehicle via the network NW using the communication part 310. For example, the providing part 324 transmits a notification that recommends restarting use of the vehicle 10 (for example, including a notification that recommends that the manager drive the specified vehicle, a notification that recommends that the vehicle be lent to and driven by another person, or the like), a notification that recommends to connect the vehicle 10 to the external power supply device 400 to perform charging or power feeding, or the like. Further, the providing part 324 may notify the user terminal device 200 of information indicating the continuous IG OFF time together with these notifications.

As a result, the notification that recommends restarting of use of the vehicle 10, a notification that recommends connecting the vehicle 10 to the external power supply device 400 and performing the charging or power feeding, or the like can be transmitted to the manager who manages the specified vehicle. The manager may be able to prevent degradation of the battery 40 by receiving the notification and restarting the use. In addition, the V2X service can be used effectively by connecting to the external power supply device 400 and increasing the number of vehicles that perform the charge/discharge.

Further, the storage 330 stores destination information in which information (for example, a mail address, identification information of a terminal, a telephone number, and the like) related to the destination when the information is transmitted to the user terminal device 200 of the manager is associated with the vehicle ID. The providing part 324 transmits the notification to each manager of the vehicle 10 by referring to the destination information.

There is no limitation thereto, and the providing part 324 may transmit the predetermined information to another external server device including the electric power company server device 500 via the network NW using the communication part 310. Hereinafter, the information transmitted to the electric power company server device 500 is sent to the other external server device, and detailed description thereof will be omitted. The other external server device includes, for example, a server device used by a person among wide-area managers who are not electric utilities.

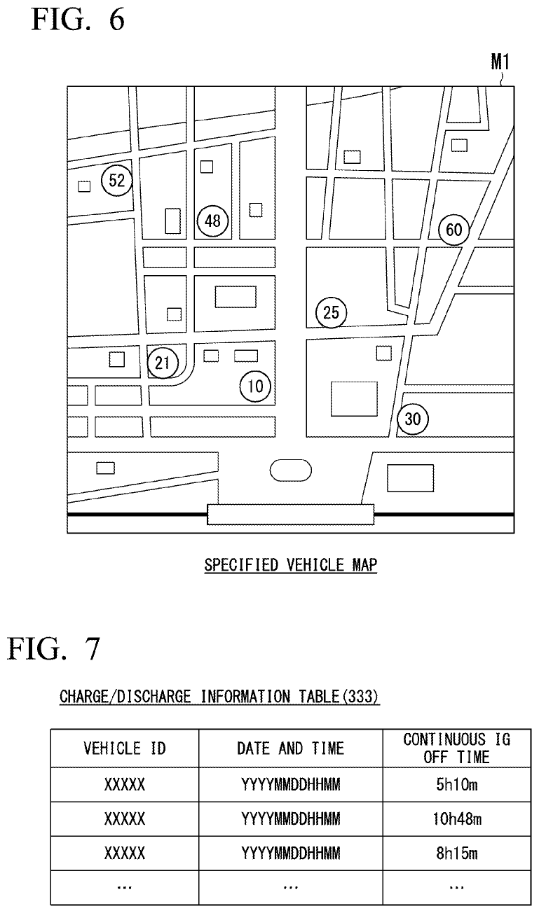

The map information generating part 325 performs predetermined processing corresponding to the specified vehicle extracted by the specified vehicle extraction part 323. For example, the map information generating part 325 generates information in which a position of the specified vehicle is mapped (hereinafter, specified vehicle map information) on the basis of the vehicle position of the situation information table 331. The specified vehicle map information is, for example, information for displaying an image, in which an image that displays an icon expressing a specified vehicle is overlapped at a position of the specified vehicle on the map, on the display. For example, the specified vehicle map information is information that displays a specified vehicle map M1 as shown in FIG. 6 on the display. There is no limitation thereto, and the specified vehicle map information may be information in which the position on the map of the specified vehicle is associated with the vehicle ID of the specified vehicle.

Further, the map information generating part 325 may add various pieces of information to the specified vehicle map by referring to the situation information table 331 or the continuous IG OFF time table 332. For example, the map information generating part 325 may generate a specified vehicle map in which the vehicle ID, the continuous IG OFF time, the residual energy quantity, and the like are related to the vehicle position and displayed.

FIG. 6 is a view showing an example of the specified vehicle map M1. The specified vehicle map M1 is, for example, information for displaying a predetermined icon at the position of the vehicle 10 on a map image to visualize the position of the vehicle 10 on the map. In the example of FIG. 6, the number of the continuous IG OFF time is displayed on the icon indicating the position of the vehicle 10. Further, the vehicle ID, the residual energy quantity, a diagnosis result of the degradation diagnosis part 327 or the like may be displayed on the icon indicating the position of the vehicle 10.

In addition, the map information generating part 325 may generate information (hereinafter referred to as related specified vehicle map information) in which the specified vehicles having a predetermined relationship among the specified vehicles extracted by the specified vehicle extraction part 323 (hereinafter referred to as a related specified vehicle) are mapped. For example, the map information generating part 325 refers to the storage 330, and generates related specified vehicle map information in which positions of the related specified vehicles managed by the same manager are mapped. Further, the storage 330 stores a list of the vehicles ID of the vehicles 10 managed by the same manager. For example, when a plurality of first specified vehicles are extracted as the specified vehicles that are vehicles managed by a first manager, the map information generating part 325 generates information in which positions of the first specified vehicles are mapped on the basis of the position information of the first specified vehicles.

In addition, the map information generating part 325 may generate related specified vehicle map information in which positions of the related specified vehicles having residual energy quantities that are a threshold or more are mapped.

Further, the map information generating part 325 may generate related specified vehicle map information in which at least two related specified vehicle types (related specified vehicles having different relationships) among a plurality of related specified vehicle types (related specified vehicles having different relationships) are combined, or may generate related specified vehicle map information in which at least one of the above mentioned plurality of related specified vehicle types and the specified vehicle are combined. In addition, similarly to the above-mentioned specified vehicle map, the map information generating part 325 may add various pieces of information to the related specified vehicle map.

When the specified vehicle map information or the related specified vehicle map information is generated by the map information generating part 325, the providing part 324 transmits the specified vehicle map information or the related specified vehicle map information that were generated to the electric power company server device 500 via the network NW using the communication part 310. In addition, when the related specified vehicle map is generated for each manager, the providing part 324 transmits the related specified vehicle map information of the specified vehicle managed by one manager to the user terminal device 200 of the one manager via the network NW using the communication part 310.

Further, the providing part 324 may transmit a recommendation notification of a predetermined operation to the vehicle 10 according to the related specified vehicle map information (for example, a notification that recommends restarting use of the vehicle 10, or a notification that recommends connecting the vehicle 10 to the external power supply device 400 and performing charging or power feeding) to the user terminal device 200 of the corresponding manager.

As a result, it is possible to recognize the positions and number of specified vehicles that have not been used for a predetermined period or longer using a map, and provide useful information when the V2X service is provided.

### [With Respect to Degradation Diagnosis]

The second acquisition part 326 acquires charge/discharge information via the network NW using the communication part 310. The charge/discharge information includes either charging information acquired upon charging or discharge information acquired upon discharge. The charging information includes, for example, physical quantity data or physical quantity time data on the basis of the detection result detected by the battery sensor 42 upon charging. The discharge information includes, for example, physical quantity data or physical quantity time data on the basis of the detection result detected by the battery sensor 42 upon discharge (power feeding). Further, there is provided information that discriminates charging information which includes, for example, a charging flag or the like, and discharge information which includes, for example, a discharge flag or the like.

The second acquisition part 326 acquires charge/discharge information from the vehicle 10. There is no limitation thereto, and when the charge/discharge information is transmitted from the vehicle 10 to the external power supply device 400 in advance, the second acquisition part 326 may acquire charge/discharge information from the external power supply device 400.

The data management part 322 stores the charge/discharge information acquired by the second acquisition part 326 as a part of the charge/discharge information table 333. FIG. 7 is a view showing an example of contents of the charge/discharge information table 333. The charge/discharge information table 333 is, for example, information in which the date and time and the charge/discharge information are associated with the vehicle ID. The date and time in the charge/discharge information table 333 is a date and time when charge or discharge is executed.

The degradation diagnosis part 327 refers to the continuous IG OFF time table 332 and the charge/discharge information table 333, and performs degradation diagnosis of the battery 40 of the vehicle 10 extracted as the specified vehicle. For example, the degradation diagnosis part 327 determines a degradation level of the battery on the basis of the physical quantity data or the physical quantity time data included in the charge/discharge information. The degradation level includes, for example, a state level R1, a state level R2, a state level R3 . . . which are in order of the battery 40 having lower degradation. There is no limitation thereto, and the degradation level may be an index indicating the degree of degradation numerically. While an example in which a degradation level of a battery is determined on the basis of physical quantity data will be described below, a degradation level of a battery may be determined on the basis of physical quantity time data.

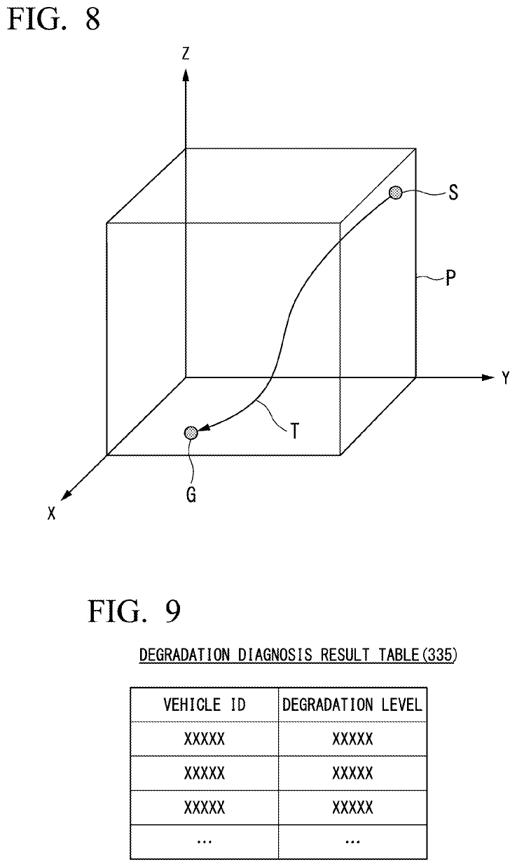

First, the degradation diagnosis part 327 generates a battery degradation diagnosis space on the basis of the physical quantity data included in the charge/discharge information. FIG. 8 is a view showing an example of the battery degradation diagnosis space according to the embodiment. For example, the degradation diagnosis part 327 generates a battery degradation diagnosis space P shown in FIG. 8 on the basis of the physical quantity data included in the charge/discharge information. For example, three axes of the battery degradation diagnosis space P are an X axis indicating an open circuit voltage of the battery 40, a Y axis indicating a capacity of the battery 40, and a Z axis indicating an internal resistance of the battery 40.

Next, the degradation diagnosis part 327 depicts a part of a trajectory T using a point S as a start point and a point G as an end point in the battery degradation diagnosis space P on the basis of the physical quantity data included in the charge/discharge information. The trajectory T is a line that connects a plurality of points indicating the open circuit voltage, the capacity and the internal resistance at each time in a period from an initial state to a final state of the battery 40. That is, the points that form the trajectory T represent an operation history of the battery 40. For example, the degradation diagnosis part 327 acquires at least one set of coordinates indicating measured values (i.e., the open circuit voltage, the capacity and the internal resistance included in the charge/discharge information) in the battery degradation diagnosis space P.

Then, the degradation diagnosis part 327 refers to the degradation level correspondence information 334 that is prepared in advance, and acquires a degradation level corresponding to the derived coordinates. The degradation level correspondence information 334 includes, for example, information in which a set of coordinates in the battery degradation diagnosis space P previously allocated according to the degradation level is associated with the degradation level of the battery.

There is no limitation thereto, and the degradation diagnosis part 327 may refer to a plurality of SOC-COV curves (while not shown, information stored in the storage 330) prepared in advance according to the degradation level and acquire a degradation level associated with the SOC-COV curve closest to SOC-COV curve characteristics included in the charge/discharge information. For example, some of information indicating the SOC-COV curve when degradation advances, information indicating the SOC-COV curve close to when the battery is new, and the like are stored in the storage 330. The degradation diagnosis part 327 can perform degradation diagnosis by fitting the SOC-COV curve characteristics measured in the current state with the SOC-COV data of the storage 330.

Further, the degradation diagnosis part 327 may perform degradation diagnosis of the secondary battery of the vehicle 10 on the basis of the continuous IG OFF time and the charge/discharge information. For example, the degradation diagnosis part 327 performs degradation diagnosis according to a first standard when a vehicle that performs degradation diagnosis is not a specified vehicle (hereinafter referred to as a non-specified vehicle), and performs degradation diagnosis according to a second standard different from the first standard when a vehicle that performs degradation diagnosis is a specified vehicle. The second standard is a diagnosis standard that is more accurate than the first standard.

For example, the first standard is first degradation level correspondence information 334A, and the second standard is second degradation level correspondence information 334B.

As described above, for example, the first degradation level correspondence information 334A and the second degradation level correspondence information 334B are information in which a set of coordinates in the battery degradation diagnosis space P previously allocated according to the degradation level is associated with the degradation level of the battery. For example, compared to the first degradation level correspondence information 334A that is the first standard, in the second degradation level correspondence information 334B that is the second standard, a larger number of coordinates included in the set of coordinates in the battery degradation diagnosis space P previously allocated according to the degradation level are provided, or an interval between the coordinates is smaller.

There is no limitation thereto, and as described above, for example, the first degradation level correspondence information 334A and the second degradation level correspondence information 334B may be a set of coordinates that define the plurality of SOC-COV curves prepared in advance according to the degradation level. For example, in the second degradation level correspondence information 334B that is the second standard, a curve pitch width of the plurality of SOC-COV curves prepared in advance according to the degradation level is smaller than in the first degradation level correspondence information 334A that is the first standard.

There is no limitation thereto, and the degradation diagnosis part 327 may perform degradation diagnosis according to the different diagnosis standards prepared according to the length of the continuous IG OFF time even in the specified vehicles. For example, as the continuous IG OFF time is lengthened, accuracy of the diagnosis standard is increased.

As a result, when a period of non-use is prolonged, degradation of the battery 40 may be advanced, and the degradation can be more accurately diagnosed by diagnosing the degradation with a standard different from the case where it was not as above.

When the degradation diagnosis of the vehicle 10 that is an object is performed by the degradation diagnosis part 327, the degradation diagnosis part 327 associates the diagnosis result with the vehicle ID, and stores the diagnosis result in the storage 330 as a part of the degradation diagnosis result table 335. FIG. 9 is a view showing an example of contents of the degradation diagnosis result table 335 according to the embodiment.

In addition, when the degradation diagnosis of the vehicle 10 that is the object is performed by the degradation diagnosis part 327, the providing part 324 transmits the diagnosis result by the degradation diagnosis part 327 to at least one of the vehicle 10 that is the object and the user terminal device 200 of the manager of the vehicle 10 that is the object via the network NW using the communication part 310. Here, the providing part 324 may transmit a notification that recommends reduction in a leaving interval, in addition to the diagnosis result, to the user terminal device 200 of the manager of the vehicle 10 that is a specified vehicle, with the degradation level that is a threshold or more (the degradation level is increased as it gets worse). The notification that recommends reduction in a leaving time includes, for example, the facts that degradation of the battery 40 is advancing, degradation of the battery 40 is promoted as the leaving time is increased, shortening the leaving time at the next stop can prevent degradation of the battery 40 of the vehicle.

Further, when degradation diagnosis of the vehicle 10 that is the object is performed by the degradation diagnosis part 327, the degradation diagnosis part 327 may derive a difference between a degradation level acquired at this time (a latest value) and a degradation level acquired at the last time (a past value), and acquire the specified vehicle in which a difference between the latest value and the past value of the degradation level is deteriorated to a threshold or more (a specified vehicle in which the degradation level is deteriorated) by determining whether the derived difference is the threshold or more. The providing part 324 transmits a notification that recommends reduction in a leaving time, in addition to the diagnosis result, to the user terminal device 200 of the manager of the specified vehicle acquired as the vehicle in which the degradation level is deteriorated.

When degradation diagnosis of all of the specified vehicles that are objects by the degradation diagnosis part 327 is performed, the map information generating part 325 generates specified vehicle map information that displays the diagnosis result by the degradation diagnosis part 327 (for example, a degradation level) in relation with the vehicle position. For example, the map information generating part 325 generates specified vehicle map information indicating a degradation diagnosis result associated with the position on the map of the specified vehicle, which is information in which the position of the specified vehicle is mapped, on the basis of the position information of the specified vehicle and the degradation diagnosis result. The providing part 324 transmits the specified vehicle map information indicating the degradation diagnosis result in association with the position on the map of the specified vehicle to the electric power company server device 500 via the network NW using the communication part 310.

In addition, for example, the map information generating part 325 may generate related specified vehicle map information that displays the degradation diagnosis result in associated with the position on the map of the related specified vehicle, which is information in which the positions of the related specified vehicles managed by the same manager are mapped. The providing part 324 transmits the related specified vehicle map information to the user terminal device 200 of the one common manager via the network NW using the communication part 310.

In addition, the map information generating part 325 may generate the related specified vehicle map information in which position of the related specified vehicle, which has the degradation level acquired by the degradation diagnosis part 327 a threshold or more (provided that the level of the degradation level is increased as the degradation level gets worse), are mapped. Further, the map information generating part 325 may generate the related specified vehicle map information in which the positions of the related specified vehicles in which the difference between the degradation level acquired at this time by the degradation diagnosis part 327 and the previous value (the degradation level acquired at the last time) is deteriorated to the threshold or more are mapped. The providing part 324 transmits the related specified vehicle map information to the electric power company server device 500 via the network NW using the communication part 310.

The map information generating part 325 may generate the related specified vehicle map information in which these related specified vehicles are combined.

In this way, the diagnosis result, a specified vehicle map that displays the diagnosis result in relation with the vehicle position, the notification that recommends reduction in a leaving interval, or the like, is transmitted to at least one of the electric power company server device 500, the vehicle 10 that is the object, and the user terminal device 200 of the manager of the vehicle 10 that is the object, and thus, it is possible to notify the information that associates “leaving the vehicle 10 without operating” and “degrading the battery 40,” which are correlated with each other. Accordingly, it is possible to strongly urge the manager not to leave the vehicle 10 without operating and to connect to the external power supply device 400, and to prevent degradation of the battery 40 from progressing.

### [With Respect to Power Feeding Vehicle]

The power feeding vehicle extraction part 328 refers to the situation information table 331, and the vehicle having the residual energy quantity that is a threshold or more, among the specified vehicles extracted by the specified vehicle extraction part 323, is extracted as the power feeding vehicle. The power feeding vehicle is a vehicle that is usable as a power supply configured to supply electric power in a specified situation. The specified situation is, for example, upon emergency such as disasters, power outages, or the like.

When the power feeding vehicle is extracted by the power feeding vehicle extraction part 328, the providing part 324 generates information related to the power feeding vehicle, and transmits the generated information to the electric power company server device 500. The information related to the power feeding vehicle includes, for example, list information in which the vehicle ID of the power feeding vehicle and the position information are associated with each other, information indicating the number of power feeding vehicles at each area, or the like.

In addition, when the power feeding vehicle is extracted by the power feeding vehicle extraction part 328, the map information generating part 325 refers to the situation information table 331, and generates information in which positions of the power feeding vehicles are mapped (hereinafter, power feeding vehicle map information). Further, the map information generating part 325 may generate power feeding vehicle map information in which positions of one or more power feeding vehicles managed by the same manager are mapped, like generation of the specified vehicle map information. The providing part 324 transmits the power feeding vehicle map information generated by the map information generating part 325 to the electric power company server device 500. In addition, the providing part 324 may transmit the power feeding vehicle map information in which positions of one or more power feeding vehicles managed by the same manager are mapped to the user terminal device 200 of one common manager.

The timing when the power feeding vehicle extraction part 328 extracts the power feeding vehicle may be predetermined periodically or when it is notified that it is an emergency. The notification that it is an emergency is obtained by the controller 320 form an external server device (not shown) via the network NW using, for example, the communication part 310.

In the case in which the power feeding vehicle is extracted at the timing when it is notified that it is an emergency, the providing part 324 transmits a notification that recommends use of the power feeding vehicle as a power feeding device with respect to the user terminal device 200 of the manager who manages the power feeding vehicle. For example, the providing part 324 transmits a notification that recommends to move the vehicle 10 close to the external power supply device 400 close thereto and to perform power feeding from the vehicle 10 to the external power supply device 400.

As a result, it is possible to previously search for the vehicle 10 that is usable as the power feeding device upon emergency.

### [With Respect to Power Feeding Electric Power Upon Emergency]

The power feeding processing part 329 derives a supply power when the power feeding vehicle extracted by the power feeding vehicle extraction part 328 is used as the power feeding device in the specified situation (hereinafter, referred to as emergency supply electric power). For example, when the information indicating that it is an emergency from the external server device (now shown) via the network NW using the communication part 310, the power feeding processing part 329 refers to the residual energy quantity of the situation information table 331 and derives the electric power, that is feedable when the residual energy quantity of the power feeding vehicle is used entirely, as the emergency supply electric power.

Further, the power feeding processing part 329 may derive a total value of electric power feedable by all the power feeding vehicles present in the target area as the emergency supply electric power.

There is no limitation thereto, and the power feeding processing part 329 derives the emergency supply electric power on the basis of the degradation diagnosis result by the degradation diagnosis part 327. For example, the power feeding processing part 329 refers to the degradation diagnosis result table 335, and may corrects the residual energy quantity of the situation information table 331 to the residual energy quantity reduced according to the degradation on the basis of the diagnosis result of the vehicle 10 extracted as the power feeding vehicle, and derive the electric power feedable when the corrected residual energy quantity is used entirely as the emergency supply electric power.

When the emergency supply electric power is derived by the power feeding processing part 329, the providing part 324 notifies the electric power company server device 500 about information indicating the emergency supply electric power.

The timing when the power feeding processing part 329 derives the emergency supply electric power may be predetermined periodically or may be the time when it is notified as an emergency.

As a result, it is possible to grasp how much electric power can be secured by the external power supply device 400 upon emergency.

Hereinafter, a flow of each processing by the vehicle monitoring server device 300 will be described using a flowchart.

### [Extraction of Specified Vehicle and Map Generation Processing]

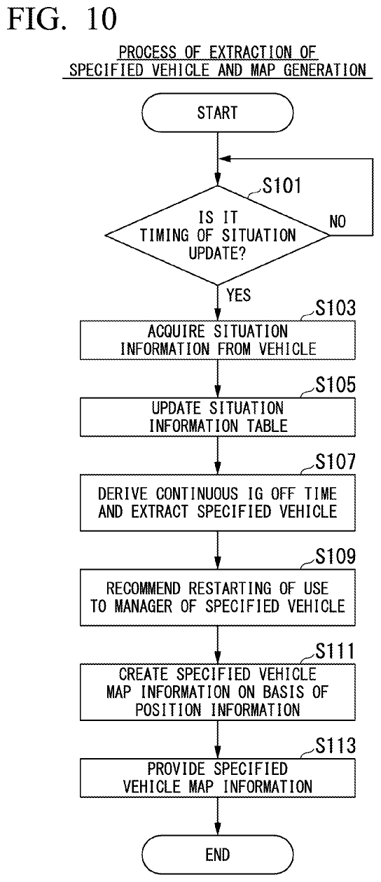

FIG. 10 is a flowchart showing an example of a flow of processing of extraction of the specified vehicle and map generation by the vehicle monitoring server device 300. First, the first acquisition part 321 determines whether it is update timing of situation information of the vehicle (step S101). When it is the update timing, the first acquisition part 321 transmits a request to the vehicle 10 and acquires the vehicle situation information (step S103). The data management part 322 updates the situation information table 331 on the basis of the vehicle situation information acquired by the first acquisition part 321 (step S105).

The specified vehicle extraction part 323 refers to the situation information table 331, derives the continuous IG OFF time with respect to all the vehicles 10 that have acquired the vehicle situation information, and updates the continuous IG OFF time table 332 at the derived continuous IG OFF time. Next, the specified vehicle extraction part 323 refers to the continuous IG OFF time table 332, and extracts the vehicle 10 in which the continuous IG OFF time is a threshold or more as the specified vehicle (step S107). Then, the providing part 324 transmits a notification that recommends restarting of use of the vehicle 10 such as connection to the external power supply device 400 or the like, a notification that recommends reduction in a leaving interval of the vehicle 10, or the like, to the user terminal device 200 of the manager who manages the extracted specified vehicle via the network NW using the communication part 310 (step S109).

Next, the map information generating part 325 generates specified vehicle map information or related specified vehicle map information in which positions of the specified vehicles extracted in step S107 are mapped on the basis of the vehicle position of the situation information table 331 (step S111). The providing part 324 transmits the generated specified vehicle map information or the generated related specified vehicle map information to the electric power company server device 500 via the network NW using the communication part 310 (step S113).

[Battery Degradation Diagnosis and Processing that Recommends Vehicle Utilization]

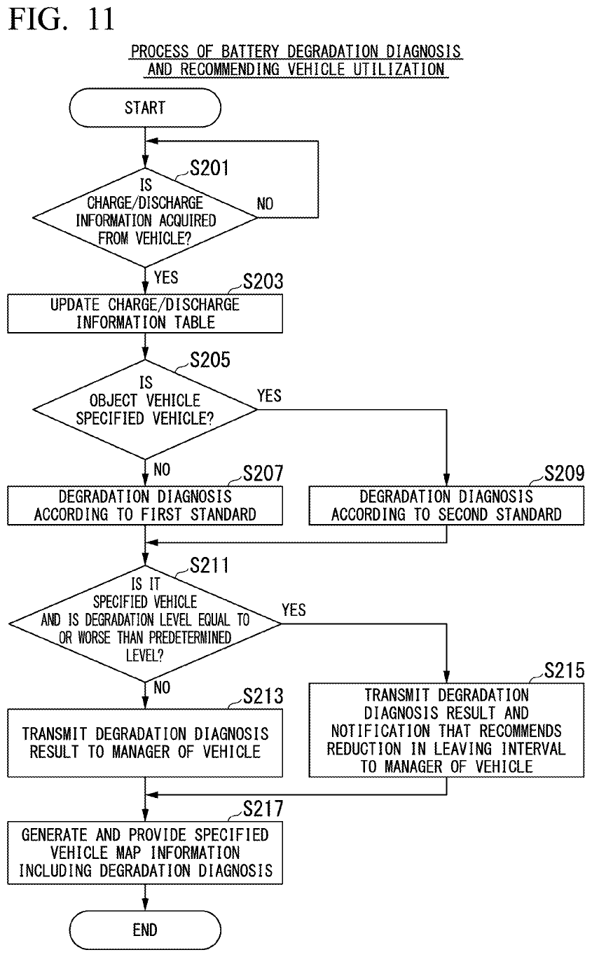

FIG. 11 is a flowchart showing an example of a flow of processing of battery degradation diagnosis and recommending vehicle utilization by the vehicle monitoring server device 300. First, the second acquisition part 326 determines whether the charge/discharge information is acquired from the vehicle 10 (step S201). For example, the vehicle 10 transmits the charging information to the vehicle monitoring server device 300 at the timing charged by the external power supply device 400, and transmits the discharge information to the vehicle monitoring server device 300 at the timing when power is fed to the external power supply device 400. The data management part 322 updates the charge/discharge information table 333 with the charge/discharge information acquired by the second acquisition part 326 (step S203).

The degradation diagnosis part 327 determines whether the vehicle that performs the degradation diagnosis is the specified vehicle (step S205). When the vehicle that performs the degradation diagnosis is not the specified vehicle, the degradation diagnosis part 327 performs the degradation diagnosis according to the first standard (step S207). Meanwhile, when the vehicle that performs the degradation diagnosis is the specified vehicle, the degradation diagnosis part 327 performs the degradation diagnosis according to the second standard (step S209).

Next, the degradation diagnosis part 327 determines whether the vehicle that is the object in which the degradation diagnosis is performed is the specified vehicle and is a vehicle with a degradation level that is a threshold or more (hereinafter, referred to as a first degradation specified vehicle) (step S211). In step S211, the degradation diagnosis part 327 may determine whether the vehicle that is the object in which the degradation diagnosis is performed is the specified vehicle and a vehicle in which a difference between the latest value and the past value of degradation level is deteriorated to a threshold or more (hereinafter, referred to as a second degradation specified vehicle).

When the vehicle that is the object in which the degradation diagnosis is performed may be neither the first degradation specified vehicle nor the second degradation specified vehicle, the providing part 324 transmits the diagnosis result to the user terminal device 200 of the manager of the vehicle that is the object on which the degradation diagnosis is performed (step S213). Meanwhile, when the vehicle that is the object in which the degradation diagnosis is performed is the first degradation specified vehicle or the second degradation specified vehicle, the providing part 324 transmits a notification that recommends reduction of a leaving interval of the vehicle, in addition to the diagnosis result, to the user terminal device 200 of the manager of the vehicle that is the object in which the degradation diagnosis is performed (step S215). In step S213 and step S215, the providing part 324 may transmit the diagnosis result to the vehicle 10 that is the object in which the degradation diagnosis is performed.

Next, when the degradation diagnosis of all the specified vehicles that are objects is performed by the degradation diagnosis part 327, the map information generating part 325 generates the specified vehicle map information that displays the diagnosis result (for example, the degradation level) by the degradation diagnosis part 327 in relation with the vehicle position, and the providing part 324 transmits the generated specified vehicle map information to the electric power company server device 500 via the network NW using the communication part 310 (step S217).

### [Battery Degradation Diagnosis and Processing of Recommending Vehicle Utilization]

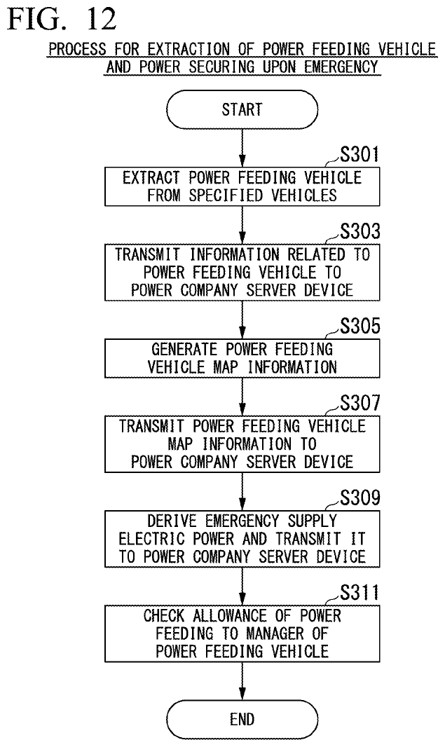

FIG. 12 is a flowchart showing an example of a flow of processing of extraction of the power feeding vehicle and securing electric power upon emergency by the vehicle monitoring server device 300. First, the power feeding vehicle extraction part 328 extracts the vehicle with the residual energy quantity that is a threshold or more, among the specified vehicles extracted by the specified vehicle extraction part 323, as the power feeding vehicle (step S301). The providing part 324 generates information in relation with the power feeding vehicle, and transmits the generated information to the electric power company server device 500 (step S303).

Next, the map information generating part 325 generates power feeding vehicle map information in which positions of the power feeding vehicles are mapped (step S305). The providing part 324 transmits the generated power feeding vehicle map information to the electric power company server device 500 (step S307).

Next, the power feeding processing part 329 derives the emergency supply electric power when used as the power feeding device in the specified situation on the basis of the degradation diagnosis result by the degradation diagnosis part 327, and the providing part 324 notifies the information indicating the emergency supply electric power to the electric power company server device 500 (step S309).

Next, the providing part 324 transmits a notification that checks whether usage as the power feeding device in the specified situation is allowed with respect to the user terminal device 200 of the manager of the power feeding vehicle (step S311). For example, when usage allowance as the power feeding device in the specified situation is input by the manager via an operation part of the user terminal device 200, the user terminal device 200 transmits the information indicating this instruction to the vehicle monitoring server device 300. The vehicle monitoring server device 300 stores the information indicating this instruction in associated with the vehicle ID in the storage 330 when the information is received.

### [Processing for Power Feeding Upon Emergency]

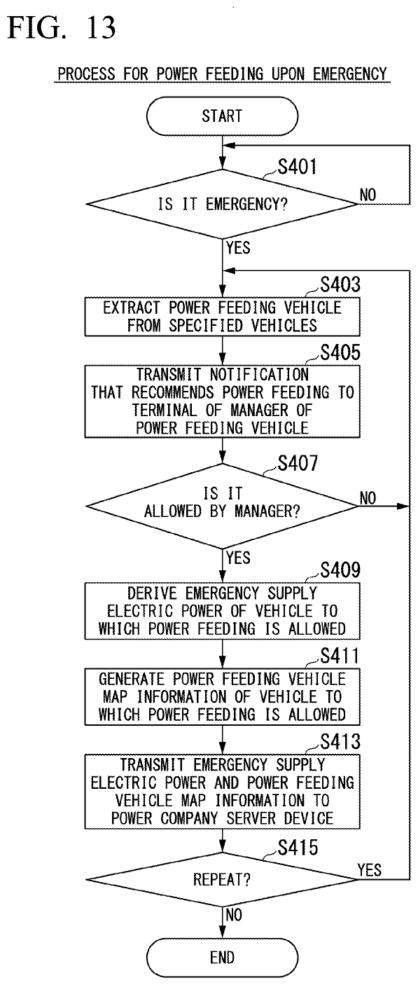

FIG. 13 is a flowchart showing an example of a flow of processing for power feeding upon emergency by the vehicle monitoring server device 300. First, the power feeding vehicle extraction part 328 determines whether a notification that it is an emergency is received (step S401). When the notification that it is an emergency is received, the power feeding vehicle extraction part 328 extracts the vehicle with the residual energy quantity that is a threshold or more, among the specified vehicles extracted by the specified vehicle extraction part 323, as the, power feeding vehicle (step S403). Next, the providing part 324 transmits the notification that the power feeding vehicle is connected to the external power supply device 400 and used as the power feeding device with respect to the user terminal device 200 of the manager of the power feeding vehicle (step S405).

Next, the power feeding processing part 329 determines whether usage as the power feeding device in the specified situation is allowed by the manager of the power feeding vehicle by referring to the storage 330 (step S407). When usage as the power feeding device is allowed by the manager of the power feeding vehicle, the power feeding processing part 329 derives the emergency supply electric power when the power feeding vehicle, power feeding of which is allowed, is used as the power feeding device in the specified situation on the basis of the degradation diagnosis result by the degradation diagnosis part 327 (step S409). Further, in the processing of step S409, when the plurality of power feeding vehicles, power feeding of which is allowed, are provided, the emergency supply electric power thereof and a total value thereof are derived.

Next, the map information generating part 325 generates power feeding vehicle map information in which positions of all the power feeding vehicles, power feeding of which is allowed, are mapped (step S411). The providing part 324 transmits the emergency supply electric power (including a total value) and the power feeding vehicle map information that were generated to the electric power company server device 500 (step S413).

Next, the power feeding processing part 329 determines whether processing for power feeding upon emergency is repeated. For example, the power feeding processing part 329 repeats the processing a predetermined number of times every few minutes from the time when a notification that it is an emergency is received. When it reaches the predetermined number of repetitions, the power feeding processing part 329 terminates the processing. Meanwhile, when it does not reaches the predetermined number of repetitions, the power feeding processing part 329 returns to step S403 and repeats the processing. As a result, when usage as the power feeding device in the specified situation is allowed gradually by the manager of the power feeding vehicle, the power feeding vehicle allowed after can be reflected to the emergency supply electric power and the power feeding vehicle map information.

Further, the vehicle 10 may be a hybrid car or a plug-in hybrid electric vehicle (PHEV) traveling by a motor (an electric motor) driven by electric power supplied according to an operation of an internal combustion engine operated by fuel or electric power supplied from a battery (a secondary battery). In this case, the above-mentioned residual energy quantity also includes a gasoline residual quantity. In addition, in degradation diagnosis of the battery included in these hybrid cars or the like, the same diagnosis processing as that of the degradation diagnosis of the battery 40 is performed.

As described above, the vehicle monitoring server device 300 of the embodiment includes the communication part in communication with one or more vehicles, the acquisition part configured to acquire the identification information of the vehicle and the starting information of the driving source of the vehicle from the vehicle using the communication part, and the processing part configured to extract the specified vehicle, a driving source of which is not started for a predetermined period or more, on the basis of the starting information and to perform a process corresponding to the specified vehicle, and thus, the vehicle that is not in use can be effectively utilized.

### Second Embodiment

A vehicle monitoring server device 300A according to the embodiment is configured to monitor a fuel cell vehicle (FCV, a fuel cell automobile). The vehicle monitoring server device 300A includes the same functional components as those of the vehicle monitoring server device 300 according to the first embodiment, and different points will be described below in brief. For example, the fuel cell automobile that is a monitoring object is an electric vehicle traveling by a driving source (for example, an electric motor) driven by electric power supplied from a fuel cell, and includes a fuel cell instead of the battery 40. The residual energy quantity includes a residual quantity of fuel (for example, hydrogen or the like) consumed to supply electric power from the fuel cell. The degradation diagnosis part 327 performs degradation diagnosis of the fuel cell on the basis of the generation number of times, gross generation, or the like, of the fuel cell. In addition, when the FCV includes the secondary battery, the degradation diagnosis part 327 may perform both of the degradation diagnosis of the fuel cell and the degradation diagnosis of the secondary battery, or may perform only the degradation diagnosis of the secondary battery.

Even in the vehicle monitoring server device 300A according to the second embodiment, the same effect as that of the first embodiment can be exhibited.

The above-mentioned embodiment can be expressed as follows.

A vehicle monitoring device including:

a storage device in which a program is stored; and

a hardware processor,

wherein, as the hardware processor executes the program stored in the storage device,

the vehicle monitoring device is configured to communicate with one or more vehicles,

acquire identification information of the vehicle and starting information of a driving source of the vehicle from the vehicle,

extract a specified vehicle, a driving source of which is not started for a predetermined period or more, on the basis of the starting information, and

perform a process corresponding to the specified vehicle.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A vehicle monitoring device comprising:
a communication part that communicates with one or more vehicles;
an acquisition part configured to acquire identification information of the vehicle and starting information of a driving source of the vehicle from the vehicle using the communication part; and
a processing part configured to extract a specified vehicle, a driving source of which is not started for a predetermined period or more, on the basis of the starting information and to perform a process corresponding to the specified vehicle.

2. The vehicle monitoring device according to claim 1, wherein the acquisition part further acquires position information of the vehicle, and
the processing part generates information in which a position of the specified vehicle is mapped on the basis of the position information.

3. The vehicle monitoring device according to claim 1, wherein the driving source of the vehicle includes a secondary battery,
the acquisition part further acquires charge/discharge information of the secondary battery, and
the processing part performs degradation diagnosis of the secondary battery of the vehicle on the basis of a period in which the driving source of the vehicle is not started and the charge/discharge information.

4. The vehicle monitoring device according to claim 3, wherein, among a plurality of vehicles that acquired the charge/discharge information, the processing part performs the degradation diagnosis of the specified vehicle with a second standard, the second standard being different from a first standard which is used when degradation diagnosis of a non-specified vehicle that is not the specified vehicle is performed, and the second standard having accuracy higher than that of the first standard.

5. The vehicle monitoring device according to claim 3, wherein the acquisition part further acquires position information of the vehicle, and
the processing part generates information in which the position of the specified vehicle is mapped and in which displays the degradation diagnosis result in association with the position of the specified vehicle on a map.

6. The vehicle monitoring device according to claim 3, wherein the processing part derives a supply power when used as a power feeding device in a specified situation on the basis of the degradation diagnosis result.

7. The vehicle monitoring device according to claim 1, wherein the communication part communicates with a terminal device of a manager who manages the specified vehicle, and transmits a notification that recommends power feeding from the specified vehicle to an external power supply device with respect to the terminal device of the manager.

8. The vehicle monitoring device according to claim 1, wherein, in a case there are a plurality of first specified vehicles, the first specified vehicle being a vehicle managed by a first manager and a vehicle being extracted as the specified vehicle,
the acquisition part further acquires position information of the first specified vehicles, and
the processing part generates information in which positions of the first specified vehicles are mapped on the basis of the position information of the first specified vehicles.

9. A vehicle monitoring method, which is performed by a computer, comprising:
communicating with one or more vehicles;
acquiring identification information of the vehicle and starting information of a driving source of the vehicle from the vehicle;
extracting a specified vehicle, a driving source of which is not started for a predetermined period or more, on the basis of the starting information; and
performing a process corresponding to the specified vehicle.

10. A computer-readable recording medium, in which a program is stored to cause a computer to:
communicate with one or more vehicles;
acquire identification information of the vehicle and starting information of a driving source of the vehicle from the vehicle;
extract a specified vehicle, a driving source of which is not started for a predetermined period or more, on the basis of the starting information; and
perform a process corresponding to the specified vehicle.
